(19) United States
(12) Patent Application Publication
(10) Pub. No.: US 2025/0244948 A1
(43) Pub. Date: Jul. 31, 2025

(54) PARAMETER CONFIGURATION METHOD, AUDIO PLAYBACK DEVICE, AND READABLE STORAGE MEDIUM

(71) Applicant: GUANGDONG OPPO MOBILE TELECOMMUNICATIONS CORP., LTD., Dongguan (CN)

(72) Inventor: Jianquan BAO, Dongguan (CN)

(21) Appl. No.: 19/185,457

(22) Filed: Apr. 22, 2025

Related U.S. Application Data
(63) Continuation of application No. PCT/CN2023/118610, filed on Sep. 13, 2023.

(30) Foreign Application Priority Data
Dec. 7, 2022 (CN) 202211567177.0

(51) Int. Cl. G06F 3/16; H04R 3/12

(52) U.S. Cl. CPC G06F 3/165; G06F 3/162; H04R 3/12

(57) ABSTRACT

Provided are a parameter configuration method, an audio playback device, and a readable storage medium. In the method, in response to a parameter adjustment condition being met, the first audio playback device adjusts synchronization parameters of the first audio playback device and the second audio playback device, so that information transmission between the first audio playback device and the second audio playback device is performed based on the adjusted synchronization parameters.

### CROSS-REFERENCE OF RELATED APPLICATION

This application is a continuation of International Application No. PCT/CN 2023/118610 filed Sep. 13, 2023, which claims priority to Chinese application No. 202211567177.0, filed Dec. 7, 2022. The entire contents of them are hereby incorporated by reference for all purposes.

### TECHNICAL FIELD

The present disclosure relates to the field of communication technology, and particularly to a parameter configuration method, an audio playback device, and a readable storage medium.

### BACKGROUND

An audio device group may consist of multiple audio playback devices. The multiple audio playback devices may transmit information to each other, so that the multiple audio playback devices can better complete the audio playback task. However, the way of information transmission between multiple audio playback devices in the related art lacks flexibility.

### SUMMARY

In view of this, the present disclosure proposes a parameter configuration method, an audio playback device and a readable storage medium.

In a first aspect, embodiments of the present disclosure provide a parameter configuration method for a first audio playback device. In the method, in response to a parameter adjustment condition being met, the first audio playback device adjusts synchronization parameters of the first audio playback device and the second audio playback device, so that information transmission between the first audio playback device and the second audio playback device is performed based on the adjusted synchronization parameters.

In a second aspect, the embodiments of the present disclosure provide an audio playback device. The audio playback device includes one or more processors and a memory. One or more programs are stored in the memory and configured to be executed by the one or more processors, and the one or more programs are configured to execute the above method.

In a third aspect, the embodiments of the present disclosure provide a non-transitory computer-readable storage medium storing program codes thereon. The program codes, when running, cause the above method to be implemented.

### BRIEF DESCRIPTION OF THE DRAWINGS

In order to more clearly illustrate technical solutions in the embodiments of the present disclosure, drawings required for the description of the embodiments will be briefly introduced below. Apparently, the drawings described below are only some embodiments of the present disclosure. For those skilled in the art, other drawings can be obtained based on these drawings without paying any creative work.

FIG. 1 is a schematic diagram illustrating an application scenario to which a parameter configuration method provided in the embodiments of the present disclosure is applied.

FIG. 2 is a flow chart of a parameter configuration method provided in an embodiment of the present disclosure.

FIG. 3 is a schematic diagram in which a first audio playback device and a second audio playback device are in a closed state as provided in an embodiment of the present disclosure.

FIG. 4 is a schematic diagram in which the first audio playback device and the second audio playback device are in an activated state as provided in an embodiment of the present disclosure.

FIG. 5 is a flow chart of a parameter configuration method provided in another embodiment of the present disclosure.

FIG. 6 is a schematic diagram illustrating a synchronization period and a synchronization window as provided in an embodiment of the present disclosure.

FIG. 7 is a schematic diagram illustrating another synchronization period and synchronization window as provided in an embodiment of the present disclosure.

FIG. 8 is a schematic diagram illustrating yet another synchronization period and synchronization window as provided in an embodiment of the present disclosure.

FIG. 9 is a schematic diagram illustrating increase of the synchronization window as provided in an embodiment of the present disclosure.

FIG. 10 is a schematic diagram illustrating shortening of the synchronization period as provided in an embodiment of the present disclosure.

FIG. 11 is a schematic diagram illustrating a conflict between an audio source device and the first audio playback device as provided in an embodiment of the present disclosure.

FIG. 12 is a flow chart of a parameter configuration method provided in yet another embodiment of the present disclosure.

FIG. 13 is a flow chart of a parameter configuration method provided in yet a further embodiment of the present disclosure.

FIG. 14 illustrates a timing diagram of a parameter configuration method provided in yet a still further embodiment of the present disclosure.

FIG. 15 illustrates a structural block diagram of a parameter configuration apparatus provided in an embodiment of the present disclosure.

FIG. 16 illustrates a structural block diagram of an electronic device provided in the embodiments of the present disclosure.

FIG. 17 is a storage unit for storing or carrying program codes provided in an embodiment of the present disclosure, the program codes are used for implementing the parameter configuration method provided in the embodiments of the present disclosure.

### DETAILED DESCRIPTION OF PREFERRED EMBODIMENTS

The technical solutions in the embodiments of the present disclosure will be clearly and comprehensively described below in conjunction with the drawings in the embodiments of the present disclosure. All other embodiments, obtained by those of ordinary skill in the art based on the embodiments in this disclosure without paying any creative work, shall fall within the scope of protection of this disclosure.

With the development of wireless communication technology, an audio device group may establish a connection with an audio source device through wireless communication, and the audio source device may transmit, through the connection, to-be-played audio data to the audio device group for playback. In some cases, the audio device group may consist of multiple audio playback devices. In this case, the multiple audio playback devices constituting the audio device group may transmit information to each other. For example, the multiple audio playback devices constituting the audio device group may be wireless earphones, and the multiple wireless earphones may transmit information to each other to establish a communication link between the multiple wireless earphones, or to switch the operating mode synchronously. Furthermore, through the information transmission between the multiple wireless earphones, it can also be ensured that the multiple wireless earphones execute the playback task synchronously.

However, after studying relevant audio device groups, the inventor found that the way in which the multiple audio playback devices constituting the audio device group in the related art transmit information to each other is still inflexible. For example, the synchronization parameters between the multiple audio playback devices in the related art are usually fixed, and the multiple audio playback devices always use the same synchronization parameters for information transmission.

Therefore, in order to alleviate the above-mentioned problem, the inventor proposed a parameter configuration method and apparatus, an audio device group and a readable storage medium provided in the present disclosure, by which it may detect whether a parameter adjustment condition is met, and then the first audio playback device may adjust synchronization parameters of the first audio playback device and a second audio playback device in response to the parameter adjustment condition being met. In this way, the synchronization parameters, based on which the information transmission between the first audio playback device and the second audio playback device is performed, can be changed in real time according to the parameter adjustment condition, thereby improving the flexibility of information transmission between multiple audio playback devices.

An application scenario involved in the embodiments of the present disclosure is first introduced below.

As illustrated in FIG. 1, an application scenario involved in the embodiments of the present disclosure includes an audio source device 100, a first audio playback device 210, and a second audio playback device 220. The first audio playback device 210 and the second audio playback device 220 may constitute an audio device group.

The first audio playback device 210 and the second audio playback device 220 may both start sending broadcast signals after being started, and the audio source device 100 may establish connections with each of the first audio playback device 210 and the second audio playback device 220 in response to the broadcast signals respectively sent by the first audio playback device 210 and the second audio playback device 220.

Optionally, the broadcast signal sent by the first audio playback device 210 may be an LE Audio broadcast signal, and the broadcast signal sent by the second audio playback device 220 may be an LE Audio broadcast signal. The communication link between the first audio playback device 210 and the audio source device 100 is established based on LE Audio, and the connection between the second audio playback device 220 and the audio source device 100 is established based on LE Audio.

As an implementation, the first audio playback device 210 and the second audio playback device 220 may both be wireless earphones. In addition, in the embodiments of the present disclosure, in addition to wireless earphones, the first audio playback device 210 and the second audio playback device 220 may be implemented in other forms. For example, the first audio playback device 210 and the second audio playback device 220 may both be wireless loudspeakers. For another example, the first audio playback device 210 may be a wireless earphone, and the second audio playback device 220 may be a wireless loudspeaker; or the first audio playback device 210 may be a wireless loudspeaker, and the second audio playback device 220 may be a wireless earphone.

It is notable that, in the embodiments of the present disclosure, the audio playback devices included in the audio device group may include more audio playback devices in addition to the first audio playback device 210 and the second audio playback device 220. Furthermore, in the embodiments of the present disclosure, the number of audio playback devices specifically included in the audio device group is not limited. For example, a third audio playback device and a fourth audio playback device may also be included.

The embodiments of the present disclosure will be described in detail below with reference to the accompanying drawings.

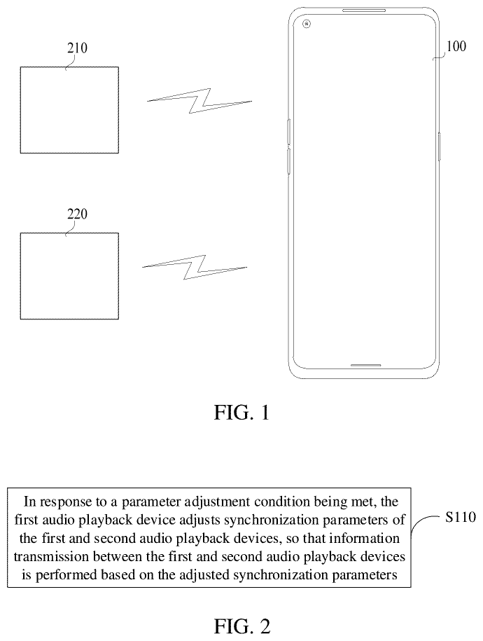

As illustrated in FIG. 2, a parameter configuration method provided in the embodiments of the present disclosure is shown. The method is applied to an audio device group including a first audio playback device and a second audio playback device. The method includes operation S110 as follows.

At S110, in response to a parameter adjustment condition being met, the first audio playback device adjusts synchronization parameters of the first audio playback device and the second audio playback device, so that information transmission between the first audio playback device and the second audio playback device is performed based on the adjusted synchronization parameters.

As an implementation, when the first audio playback device and the second audio playback device are in an operating state, in response to the parameter adjustment condition being met, the synchronization parameters of the first audio playback device and the second audio playback device are adjusted. The synchronization parameters may be understood as parameters based on which the first audio playback device and the second audio playback device perform information transmission therebetween. In this case, the synchronization parameter is used by the first audio playback device to determine the timing or frequency of transmitting information to the second audio playback device.

The operating state of the first audio playback device and the second audio playback device may be understood as a state of the first audio playback device and the second audio playback device after they are started. For the first audio playback device and the second audio playback device implemented in different ways, the corresponding starting may be understood differently.

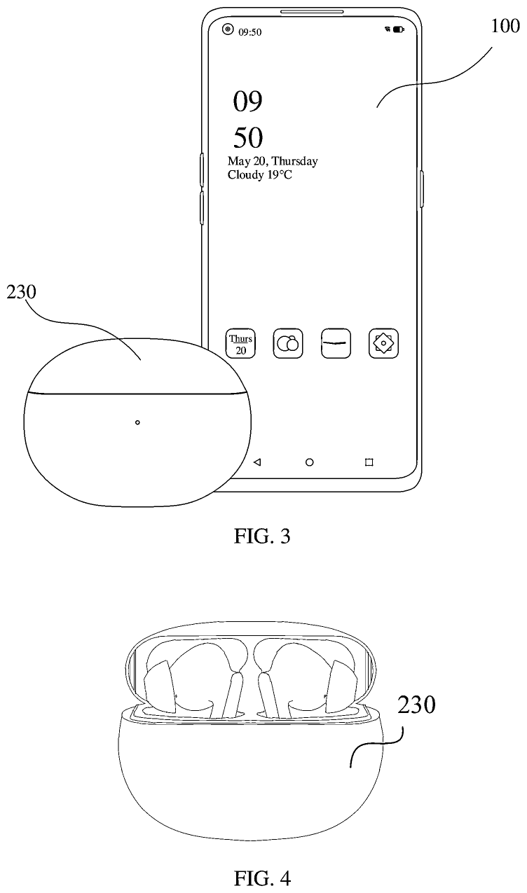

Optionally, taking, as an example, a case where the first audio playback device and the second audio playback device are a pair of wireless earphones that may be placed in an earphone case as shown in FIG. 3 and FIG. 4, when the lid of the earphone case 230 is switched from being in a closed state shown in FIG. 3 to being in an open state shown in FIG. 4, each of the first audio playback device and the second audio playback device may start sending a broadcast signal, and this may show that the first audio playback device and the second audio playback device are started. Furthermore, taking, as an example, a case where the first audio playback device and the second audio playback device are wireless loudspeakers, in this case, when the first audio playback device and the second audio playback device are powered on, it shows that the first audio playback device and the second audio playback device are started. In addition, as another implementation, the operating state may also be understood as a state in which the first audio playback device and the second audio playback device synchronously play audio. It is notable that, after the first audio playback device and the second audio playback device are started, a communication link may be established directly or indirectly with an audio source device (for example, a smart phone, a tablet computer, or a smart watch), and then the audio data may be acquired from the audio source device for playback.

Directly establishing a communication link with the audio source device may be understood as directly establishing a communication link with the audio source device without the aid of other devices. Indirectly establishing a communication link with the audio source device may be understood as performing data transmission with the audio source device by means of an intermediate device. For example, each of the first audio playback device and the second audio playback device may establish a communication link with the audio source device. Furthermore, it may be a case that the first audio playback device establishes a communication link with the audio source device, and the second audio playback device obtains the audio data sent by the audio source device through the first audio playback device. After the first audio playback device and the second audio playback device establish the communication link(s) with the audio source device, the audio source device may transmit audio data to the first audio playback device and the second audio playback device. Correspondingly, when the first audio playback device and the second audio playback device play the received audio data synchronously, it shows that the first audio playback device and the second audio playback device are in the operating state.

When the first audio playback device and the second audio playback device are in the operating state, it may be detected whether the parameter adjustment condition is met. It may be detected, based on the information transmission status between the first audio playback device and the second audio playback device, whether the parameter adjustment condition is met. In this case, the parameter adjustment condition also represents the information transmission status between the first audio playback device and the second audio playback device. The information transmission status may include a first retransmission rate of information transmission, and/or whether there is designated information to be transmitted. The first retransmission rate may be understood as a retransmission rate between the first audio playback device and the second audio playback device. In some implementations, between the first audio playback device and the second audio playback device, after the sender of information sends the information to the receiver, the receiver may return different response information according to whether the information is successfully received. For example, if the receiver determines that the information is successfully received, the receiver may return an ACK (Acknowledge character) confirmation frame to the sender of the information; otherwise, the receiver may return a NAK (Negative Acknowledgment) confirmation frame to the sender, to trigger the sender to resend the information that was not successfully received. In this case, the number of times of information retransmission may be determined based on the number of times the receiver returns the NAK confirmation frame. Then, the first retransmission rate may be determined based on the number of times of information retransmission and the total number of times of information transmission. The total number of times of information transmission includes the number of unsuccessful receptions and the number of successful receptions. It is notable that the aforementioned sender and receiver are relative. If the sender is the first audio playback device, the receiver is the second audio playback device. Correspondingly, if the sender is the second audio playback device, the receiver is the first audio playback device.

In the embodiments of the present disclosure, the designated information may include information needing to be transmitted in time/timely. For example, the information needing to be transmitted in time may include information about switching of the operating mode, and may also include information about the external device to which the audio playback device is connected. The operating mode may include a noise reduction mode and a sound enhancement mode. Furthermore, the information needing to be transmitted in time may also include relevant information about the content of the currently played audio. It is notable that, when the audio source device transmits the audio data, it encodes the audio data into packets and transmits them to the audio playback devices (for example, the first audio playback device and the second audio playback device), and the encoded packets have corresponding serial numbers. In this case, the first audio playback device may periodically synchronize, to the second audio playback device, the serial number of the packet to which the played audio data belongs, so that the serial numbers of the packets to which the audio data played by the first audio playback device and the second audio playback device at the same time are the same.

Based on the foregoing, it is possible to detect, based on the information transmission status between the first audio playback device and the second audio playback device, whether the parameter adjustment condition is met. As an implementation, the parameter adjustment condition include that: the first retransmission rate between the first audio playback device and the second audio playback device meets a retransmission rate condition, and/or it is detected that there is designated information needing to be synchronized. Correspondingly, adjusting the synchronization parameters of the first audio playback device and the second audio playback device may include: adjusting a synchronization window between the first audio playback device and the second audio playback device, and/or adjusting a synchronization period between the first audio playback device and the second audio playback device. The synchronization window may be understood as a time period during which information transmission is available within one synchronization period, and the synchronization period may be understood as a cycle at which the information transmission is performed.

It is noted that the first retransmission rate between the first audio playback device and the second audio playback device also represents the probability of successful information transmission between the first audio playback device and the second audio playback device. During one information transmission, if the first audio playback device sends to-be-transmitted information to the second audio playback device, but the second audio playback device does not successfully receive the information (for example, the second audio playback device does not return a confirmation message, or returns a NAK confirmation frame), the first audio playback device would try to send the unsuccessfully sent information again, which causes the information retransmission. When the first retransmission rate between the first audio playback device and the second audio playback device meets the retransmission rate condition, the first retransmission rate between the first audio playback device and the second audio playback device may be changed by adjusting the synchronization window between the first audio playback device and the second audio playback device.

Furthermore, the information transmission between the first audio playback device and the second audio playback device may be performed periodically. By changing the synchronization period, the frequency of information transmission between the first audio playback device and the second audio playback device may be changed, which causes the frequency of information transmission between the first audio playback device and the second audio playback device to be faster or slower.

In some implementations, the parameter adjustment condition may include that: the first retransmission rate between the first audio playback device and the second audio playback device meets the retransmission rate condition. In this case, adjusting the synchronization parameters of the first audio playback device and the second audio playback device includes: adjusting the synchronization window between the first audio playback device and the second audio playback device. In some implementations, the parameter adjustment condition may include that: it is detected that there is designated information needing to be synchronized. In this case, adjusting the synchronization parameters of the first audio playback device and the second audio playback device may include: adjusting the synchronization period between the first audio playback device and the second audio playback device.

As an implementation, the first audio playback device may determine, according to the parameter adjustment condition currently met, a corresponding synchronization parameter configuration strategy. The parameter adjustment condition may include various contents. Therefore, it may be determined that the parameter adjustment condition is met in many cases. Furthermore, for parameter adjustment conditions with different contents, the corresponding synchronization parameter configuration strategies may be different. Accordingly, after it is determined that the parameter adjustment condition is met, a synchronization parameter configuration strategy corresponding to the met parameter adjustment condition is further acquired. After the first audio playback device acquires the synchronization parameter configuration strategy, the synchronization parameters of the first audio playback device and the second audio playback device may be adjusted based on the synchronization parameter configuration strategy. For example, if the acquired synchronization parameter configuration strategy includes adjusting the synchronization window between the first audio playback device and the second audio playback device, the first audio playback device would adjust the length of the synchronization window during which the information transmission between the first audio playback device and the second audio playback device is performed, so that the information transmission between the first audio playback device and the second audio playback device is performed based on the synchronization window of the adjusted length. For another example, if the acquired synchronization parameter configuration strategy includes adjusting the synchronization period between the first audio playback device and the second audio playback device, the first audio playback device would adjust the length of the synchronization period at which the information transmission between the first audio playback device and the second audio playback device is performed, so that the information transmission between the first audio playback device and the second audio playback device is performed based on the synchronization period of the adjusted length.

As an implementation, in adjusting the synchronization parameters, the first audio playback device may send an instruction for synchronization parameter adjustment to the second audio playback device, so as to instruct the second audio playback device to adjust the synchronization parameter of the second audio playback device. If the first audio playback device receives information that is returned by the second audio playback device and indicates that the instruction has been successful responded, the first audio playback device adjusts the synchronization parameter of the first audio playback device.

It is notable that, when the first audio playback device determines that the synchronization parameters need to be adjusted, if the synchronization parameter of the first audio playback device is adjusted directly, the synchronization parameters of the first audio playback device and the second audio playback device may be inconsistent, thereby causing unsuccessful information transmission. For example, when the instruction for synchronization parameter adjustment sent by the first audio playback device to the second audio playback device is not successfully received by the second audio playback device, the second audio playback device would not adjust the synchronization parameter thereof. In this case, if the first audio playback device unilaterally adjusts the synchronization parameter thereof, the synchronization parameters of the first audio playback device and the second audio playback device would be inconsistent. When the first audio playback device receives, from the second audio playback device, information indicating that the instruction has been successful responded, it shows that the second audio playback device has successfully responded to the instruction. Correspondingly, the first audio playback device adjusts the synchronization parameter of the first audio playback device at that time, thereby ensuring that the first audio playback device and the second audio playback device can adjust the synchronization parameters synchronously.

The instruction for synchronization parameter adjustment may carry not only the determined synchronization adjustment way, but also an update time. In this case, the instruction for synchronization parameter adjustment is specifically used to instruct the second audio playback device to adjust, based on the update time, the synchronization parameter the second audio playback device. Correspondingly, the first audio playback device adjusts the synchronization parameter of the first audio playback device based on the update time. It is notable that, in some cases, after the first audio playback device detects that the parameter adjustment condition is met, the synchronization parameters may not be adjusted immediately, but may be adjusted after a period of time. Alternatively, the synchronization parameters may be adjusted until a specified time is reached. The update time represents the specific time at which the synchronization parameters will be adjusted.

In the parameter configuration method provided by the embodiments, in the case where the audio device group includes the first audio playback device and the second audio playback device, when the first audio playback device and the second audio playback device are in the operating state, in response to a parameter adjustment condition being met, the first audio playback device may acquire a synchronization parameter configuration strategy corresponding to the parameter adjustment condition, and adjusts the synchronization parameters of the first audio playback device and the second audio playback device based on the synchronization parameter configuration strategy. In this way, the synchronization parameters, based on which the information transmission between the first audio playback device and the second audio playback device is performed, can be changed in real time according to the parameter adjustment condition, thereby improving the flexibility of information transmission between multiple audio playback devices.

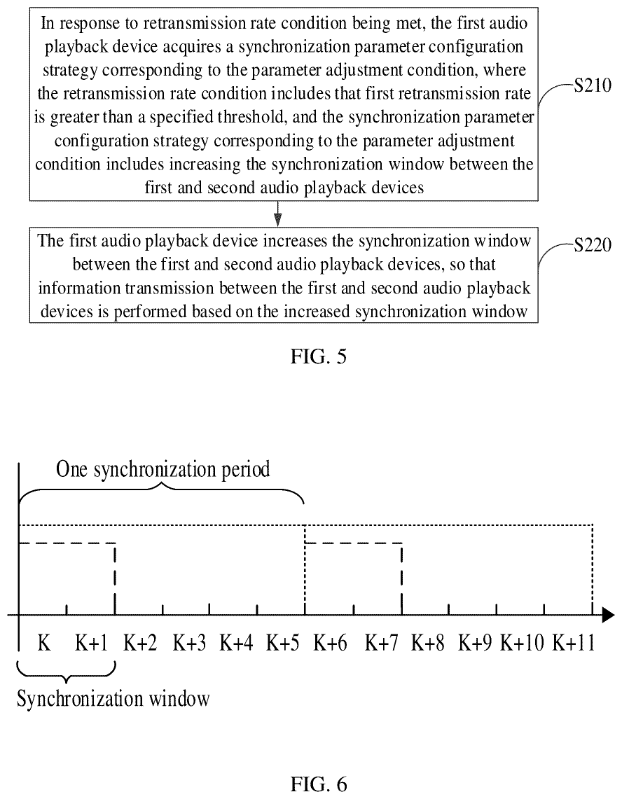

As illustrated in FIG. 5, a parameter configuration method provided in an embodiment of the present disclosure is shown. The method is applied to the first audio playback device, and the method includes operations S210-S220.

At S210, in response to the retransmission rate condition being met, the first audio playback device acquires a synchronization parameter configuration strategy corresponding to the parameter adjustment condition, where the retransmission rate condition includes that the first retransmission rate is greater than a specified threshold, and the synchronization parameter configuration strategy corresponding to the parameter adjustment condition includes increasing the synchronization window between the first audio playback device and the second audio playback device.

In the embodiments of the present disclosure, information transmission between the first audio playback device and the second audio playback device is performed within a synchronization period. Specifically, one synchronization window is set in one synchronization period, and the synchronization window may be understood as a time period during which the information transmission is actually performed in the synchronization period. Exemplarily, as illustrated in FIG. 6, there are 12 time slots, i.e., K, K+1, . . . to K+11, where every 6 time slots may define one synchronization period. In each synchronization period, the time length of 2 time slots may be taken as a synchronization window, for example, time slot K and time slot K+1 constitute one synchronization window in one period.

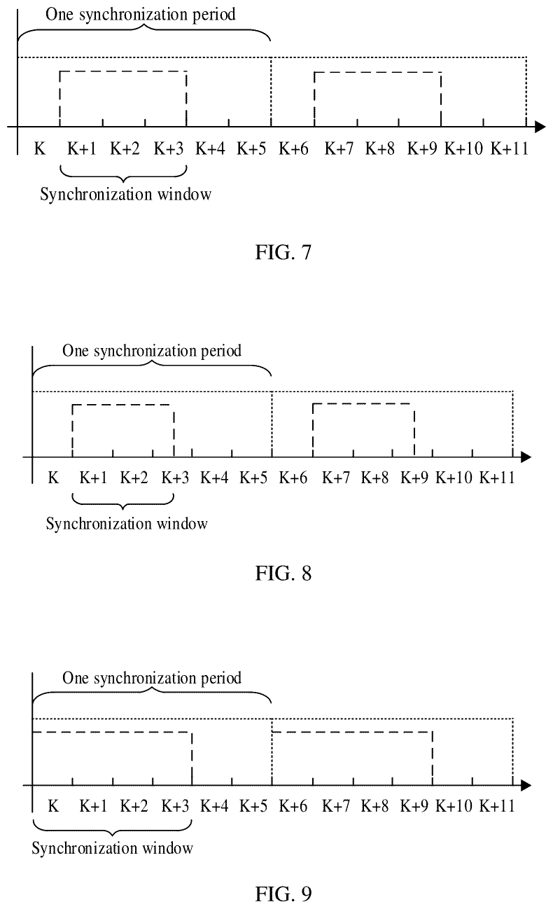

FIG. 6 is only an exemplary illustration of the synchronization period and the synchronization window. For example, the start time of the synchronization window within a synchronization period may be the same as the start time of the synchronization period, alternatively, the start time of the synchronization window may be an intermediate time within the synchronization period, as shown in FIG. 7. Furthermore, the start time of the synchronization window is not necessarily the start time of a certain time slot, but may also be a middle time of a certain time slot. Correspondingly, as shown in FIG. 8, the end time of the synchronization window is not necessarily the end time of a certain time slot, but may also be a middle time of a certain time slot. In addition, the lengths of the synchronization period and the synchronization window in FIG. 6 are only exemplary. For example, in one case, the length of the synchronization period may also be 104 time slots, and the length of the synchronization window may also be 8 time slots. In another case, the synchronization period may be 208 time slots, and the length of the synchronization window may also be 6 time slots.

It is notable that, in the embodiments of the present disclosure, information transmission between multiple audio devices may be performed within the synchronization window. Moreover, a part of the time slots within one synchronization window may be used for first information transmission within the synchronization window. If the first information transmission fails, the remaining time slots within the synchronization window may be used to retransmit the information that was failed to be transmitted. Therefore, the longer the synchronization window, the more retransmissions can be performed. In the embodiments of the present disclosure, if it is detected that the first retransmission rate between the first audio playback device and the second audio playback device is greater than the specified threshold, it shows that there is a low success rate of information transmission between the first audio playback device and the second audio playback device. Then, by increasing the length of the synchronization window, more information retransmissions may be performed within one synchronization period, which is conducive to a higher probability of successful transmission of the information.

In the embodiments of the present disclosure, there may be multiple ways to increase the synchronization window between the first audio playback device and the second audio playback device.

As an implementation, increasing the synchronization window between the first audio playback device and the second audio playback device may include: increasing the length of the synchronization window between the first audio playback device and the second audio playback device to a first specified window length. In this implementation, a relatively long window length such as the first specified window length may be preset, and a relatively short window length such as a second specified window length may be preset. In this case, after the first audio playback device and the second audio playback device start to be in the operating state, the information transmission may be performed with a default window length, and the default window length is smaller than the first specified window length. For example, the default window length may be the second specified window length, or the default window length may be between the second specified window length and the first specified window length. Afterwards, if it is detected in the operating state that the first retransmission rate is greater than the specified threshold, the window length of the synchronization window between the first audio playback device and the second audio playback device may be increased to the first specified window length.

The default window length, the first specified window length and the second specified window length are not specifically limited in the embodiments of the present disclosure. For example, the first specified window length may be 8 time slots, and the second specified window length may be 6 time slots.

As another implementation, increasing the synchronization window between the first audio playback device and the second audio playback device may include: increasing the length of the synchronization window between the first audio playback device and the second audio playback device by a specified value. Optionally, the increased value may be in units of time slots. For example, 2 time slots may be increased, or 3 time slots may be increased. In this implementation of increasing the length by the specified value, the specified value may be determined based on multiple ways.

As a determination way, the specified value may be configured by a developer by default before the audio device group leaves the factory. In this way, the first audio playback device may increase the length of the synchronization window based on the default specified value.

As another determination way, the first audio playback device may determine the specified value based on an amplitude by which the first retransmission rate is greater than the specified threshold. Optionally, the larger the magnitude by which the first retransmission rate is greater than the specified threshold, the larger the determined specified value. This enables the length of the synchronization window to be dynamically increased according to the first retransmission rate.

The magnitude by which the first retransmission rate is greater than the specified threshold may be determined based on a difference between the first retransmission rate and the specified threshold. The larger the difference, the greater the magnitude by which the first retransmission rate is greater than the specified threshold. Furthermore, correspondences between amplitudes by which the first retransmission rate is greater than the specified threshold and the specified values may be pre-established, and the specified value for the current increase may be queried based on the correspondences. For example, the correspondences nay be those shown in the following table:

| ID | Difference | Specified value |
|---|---|---|
| 1 | a | S1 |
| 2 | b | S2 |
| 3 | c | S3 |

As shown in the above table, the specified value corresponding to difference “a” is S1, the specified value corresponding to difference “b” is S2, and the specified value corresponding to difference “c” is S3. If the difference between the first retransmission rate and the specified threshold matches difference “a”, the length of the synchronization window between the first audio playback device and the second audio playback device may be increased by S1. The matching of differences may be understood that the two differences are the same, or a difference between the two differences is smaller than a preset difference threshold.

At S220, the first audio playback device increases the synchronization window between the first audio playback device and the second audio playback device, so that information transmission between the first audio playback device and the second audio playback device is performed based on the increased synchronization window.

After the synchronization window is increased, the information transmission between the first audio playback device and the second audio playback device may be performed based on the increased synchronization window.

It is notable that, increasing the synchronization window may increase the number of retransmissions of unsuccessfully sent information. However, because the audio playback device also needs to communicate with the audio source device, after the synchronization window between the audio playback devices are increased, the first retransmission rate may be decreased but not decreased to be less than the specified threshold. In this case, the synchronization period may be further shortened to further increase the frequency of sending the information that was not successfully sent.

As an implementation, after the first audio playback device adjusts, based on the synchronization parameter configuration strategy, the synchronization parameters of the first audio playback device and the second audio playback device, the first audio playback device may also detect whether the first retransmission rate is lower than the specified threshold. If it is detected that the first retransmission rate is not lower than the specified threshold, the synchronization period between the first audio playback device and the second audio playback device is shortened.

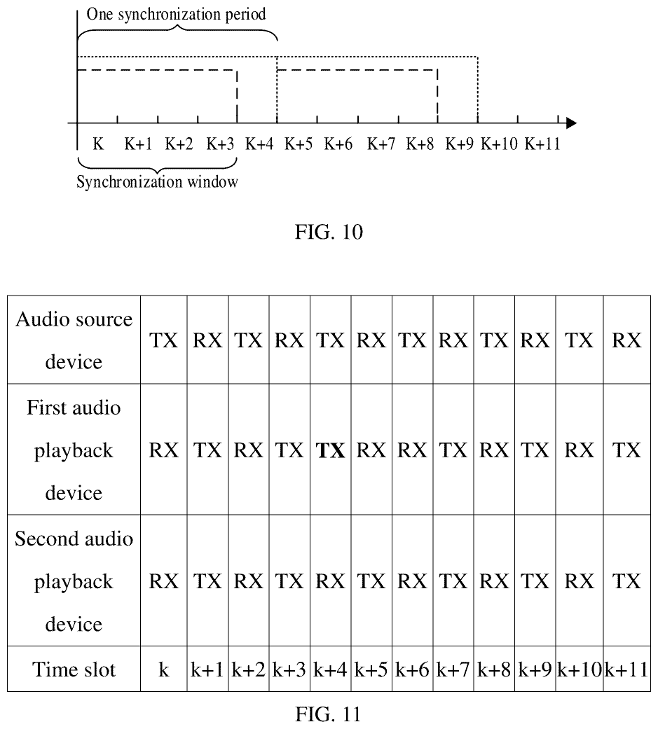

Exemplarily, after the first audio playback device and the second audio playback device start to be in the operating state, the acquired synchronization window and synchronization period may be as shown in FIG. 6. Afterwards, if the synchronization window is increased, as shown in FIG. 9, the synchronization window may be increased from occupying 2 time slots in FIG. 6 to occupying 4 time slots in FIG. 9. Afterwards, if the synchronization period is further shortened, the synchronization period may be shortened by one time slot as shown in FIG. 10.

It is notable that, after the synchronization window is increased, the time slots occupied by the synchronization window in the synchronization period is increased. After the synchronization window is increased, if the synchronization period needs to be further shortened, it may first detect whether the operation of shortening the synchronization period would affect the current synchronization window. If the operation of shortening the synchronization period would not affect the current synchronization window, the synchronization period may be shortened. Correspondingly, if the operation of shortening the synchronization period would affect the current synchronization window, the synchronization period is not shortened. The expression that “the operation of shortening the synchronization period would affect the current synchronization window” may be understood that the time slots occupied by the shortened synchronization period is not greater than the time slots occupied by the synchronization window.

After the synchronization window is increased in the aforementioned manner, the first retransmission rate may still be detected in real time. If the first retransmission rate is detected to be not greater than the specified threshold, the length of the synchronization window may be synchronously reduced. For example, the synchronization window may be restored to its original length before the increase. Correspondingly, if the synchronization period is further shortened after the synchronization window is increased, when the first retransmission rate is detected not to be greater than the specified threshold, the synchronization period is also increased synchronously, for example, increased to the original length before shortening.

In the parameter configuration method provided in the embodiment, when the first audio playback device and the second audio playback device are in the operating state, in response to detecting that a parameter adjustment condition is met, the synchronization window between the first audio playback device and the second audio playback device is increased by triggering a synchronization parameter configuration strategy corresponding to the parameter adjustment condition. In this way, the synchronization window, based on which information transmission between the first audio playback device and the second audio playback device is performed, can be changed in real time according to the parameter adjustment condition, thereby improving the flexibility of information transmission between multiple audio playback devices. Furthermore, in the embodiment, the first audio playback device increases the synchronization window between the first audio playback device and the second audio playback device in response to the first retransmission rate being greater than a specified threshold, thereby improving the success rate of information transmission between the first audio playback device and the second audio playback device, reducing the first retransmission rate between the first audio playback device and the second audio playback device, and improving the anti-interference capability of the audio device group.

Furthermore, as illustrated in FIG. 11, when information interaction is performed between multiple audio playback devices, the interaction may be initiated by the first audio playback device. In this case, when information transmission is performed between multiple audio devices, it is necessary for the first audio playback device to perform, in its own RX (Receive Data) time slot, the information sending operation that is supposed to be performed in the TX (Transmit Data) time slot, so that the second audio playback device may receive the synchronized information. If the audio source device is also in the TX time slot at this time, the audio source device and the first audio playback device are both be in the TX time slot, and the first audio playback device would experience packet loss and be unable to receive the data sent by the audio source device, and then cannot reply ACK to the audio source device. Eventually, the audio source device needs to retransmit the data until the first audio playback device replies ACK to the audio source device. As illustrated in FIG. 11, at time slot k+4, the interaction between the first audio playback device and the audio source device would conflict with the synchronization between the multiple audio playback devices, and the audio source device inevitably retransmits the data of k+4 at time slot k+6. One reason for the above-mentioned conflict is that the first retransmission rate between the first audio playback device and the second audio playback device is relatively high, which causes the first audio playback device to consume more time slots for executing information interaction between the audio playback devices. Therefore, while improving the success rate of information transmission between the first audio playback device and the second audio playback device, the audio playback device can have sufficient time to interact with the audio source device, which is also conducive to reducing the second retransmission rate between the audio source device and the audio playback device, thereby improving the anti-interference ability of the audio playback device and providing a better user experience.

Furthermore, in the case where the audio source device supports simultaneous communication with the audio playback devices and other devices, and the audio source device shares the same communication resources during the process of simultaneous communication with the audio playback devices and other devices, if the second retransmission rate between the audio source device and the audio playback device is reduced, it is also beneficial to reduce the impact on the communication between the audio source device and the other devices. For example, the audio source device may communicate with the audio playback devices (the first audio playback device and the second audio playback device) via Bluetooth communication, and the audio source device also supports communication with other devices based on WiFi. When the second retransmission rate between the audio source device and the audio playback devices is reduced, it is helpful to reduce the impact on the WiFi performance of the audio source device.

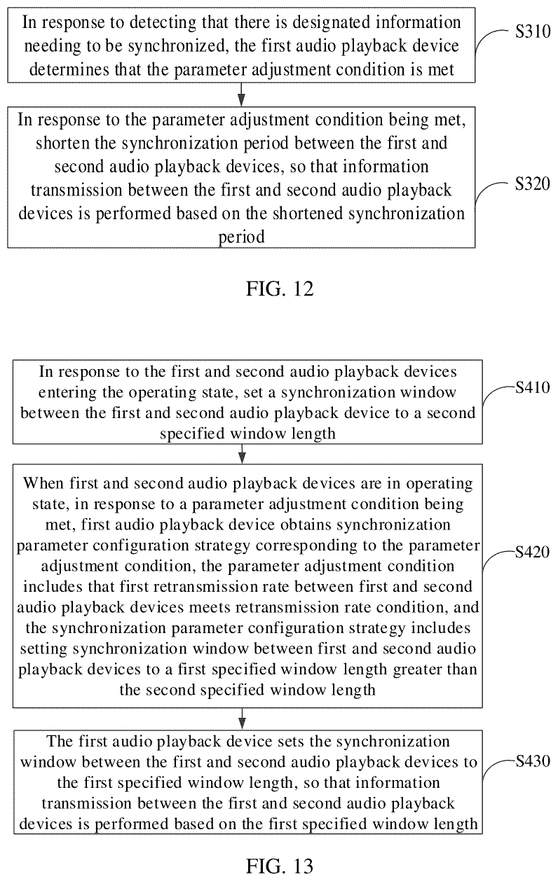

As illustrated in FIG. 12, a parameter configuration method provided in an embodiment of the present disclosure is shown. The method is applied to the first audio playback device, and the method includes operations S310-S320 as follows.

At S310, in response to detecting that there is designated information needing to be synchronized, the first audio playback device determines that the parameter adjustment condition is met.

As illustrated in the foregoing in the embodiments of the present disclosure, the designated information may be understood as information needing to be transmitted in time. In order to synchronize the information needing to be transmitted in time between multiple audio playback devices in time, the synchronization period may be adjusted first.

At S320, in response to the parameter adjustment condition being met, the synchronization period between the first audio playback device and the second audio playback device is shortened, so that information transmission between the first audio playback device and the second audio playback device is performed based on the shortened synchronization period.

In the embodiments of the present disclosure, there are multiple ways to shorten the synchronization period between the first audio playback device and the second audio playback device.

As one implementation, shortening the synchronization period between the first audio playback device and the second audio playback device may include: shortening the synchronization period between the first audio playback device and the second audio playback device to a first specified period. In this implementation, a relatively long synchronization period such as a second specified period may be preset, and a relatively short synchronization period such as the first specified period may also be preset. In this case, after the first audio playback device and the second audio playback device start to be in the operating state, information transmission may be performed with a default synchronization period, and the default synchronization period is greater than the first specified period. For example, the default synchronization period may be the second specified period, or the period length of the default synchronization period may be between the second specified period and the first specified period. Afterwards, if it is detected in the operating state that there is designated information needing to be transmitted, the synchronization period between the first audio playback device and the second audio playback device may be shortened to the first specified period.

The period lengths of the default synchronization period, the first specified period, and the second specified period are not specifically limited in the embodiments of the present disclosure. For example, the period length of the first specified period may be 78 to 156 time slots, and the period length of the second specified period may be 208 to 312 time slots. As an implementation, the length of the first specified period is 104 time slots and the length of the second specified period is 208 time slots.

As another implementation, shortening the synchronization period between the first audio playback device and the second audio playback device may include: shortening the synchronization period between the first audio playback device and the second audio playback device by a specified value. Optionally, the shortened value may be in units of time slots. For example, 2 time slots may be shortened, or 3 time slots may be shortened.

In the parameter configuration method provided in the embodiment, when the first audio playback device and the second audio playback device are in the operating state, in response to detecting that a parameter adjustment condition is met, the synchronization period between the first audio playback device and the second audio playback device is reduced. In this way, the synchronization period, based on which the information transmission between the first audio playback device and the second audio playback device is performed, can be changed in real time according to the parameter adjustment condition, thereby improving the flexibility of information transmission between multiple audio playback devices. Furthermore, in the embodiment, in response to detecting that the first audio playback device has designated information needing to be synchronized to the second audio playback device in time, the synchronization period between the first audio playback device and the second audio playback device can be shortened, thereby allowing the first audio playback device to synchronize the designated information in time.

As illustrated in FIG. 13, a parameter configuration method provided in an embodiment of the present disclosure is shown. The method is applied to the first audio playback device, and the method includes operations S410-S430 as follows.

At S410, in response to the first audio playback device and the second audio playback device entering the operating state, the length of a synchronization window between the first audio playback device and the second audio playback device is set to a second specified window length.

At S420, when the first audio playback device and the second audio playback device are in the operating state, in response to a parameter adjustment condition being met, the first audio playback device obtains a synchronization parameter configuration strategy corresponding to the parameter adjustment condition, where the parameter adjustment condition includes that the first retransmission rate between the first audio playback device and the second audio playback device meets the retransmission rate condition, and the synchronization parameter configuration strategy corresponding to the parameter adjustment condition includes setting the length of the synchronization window between the first audio playback device and the second audio playback device to a first specified window length, where the first specified window length is greater than the second specified window length.

At S430, the first audio playback device sets the length of the synchronization window between the first audio playback device and the second audio playback device to the first specified window length, so that information transmission between the first audio playback device and the second audio playback device is performed based on the first specified window length.

As an implementation, in the embodiment, it further includes: in response to the first audio playback device and the second audio playback device entering the operating state, setting the synchronization period between the first audio playback device and the second audio playback device to a second specified period. In this case, the parameter adjustment condition includes that it is detected that there is designated information needing to be synchronized, and the synchronization parameter configuration strategy corresponding to the parameter adjustment condition includes setting the synchronization period between the first audio playback device and the second audio playback device to a first specified period, and the first specified period is smaller than the second specified period.

In the parameter configuration method provided in the embodiment, the synchronization parameters, based on which information transmission between the first audio playback device and the second audio playback device is performed, can be changed in real time according to the parameter adjustment condition, thereby improving the flexibility of information transmission between multiple audio playback devices. Moreover, in the embodiment, before the first audio playback device and the second audio playback device enter the operating state, the information transmission may be performed based on a shorter synchronization window or a longer synchronization period. After the first audio playback device and the second audio playback device enter the operating state, the synchronization window between the first audio playback device and the second audio playback device may be increased, and/or the synchronization period between the first audio playback device and the second audio playback device may be shortened. This is beneficial for improving the probability of successful information transmission between the first audio playback device and the second audio playback device after the first audio playback device and the second audio playback device enter the operating state, and can also reduce power consumption while ensuring normal synchronous transmission of information.

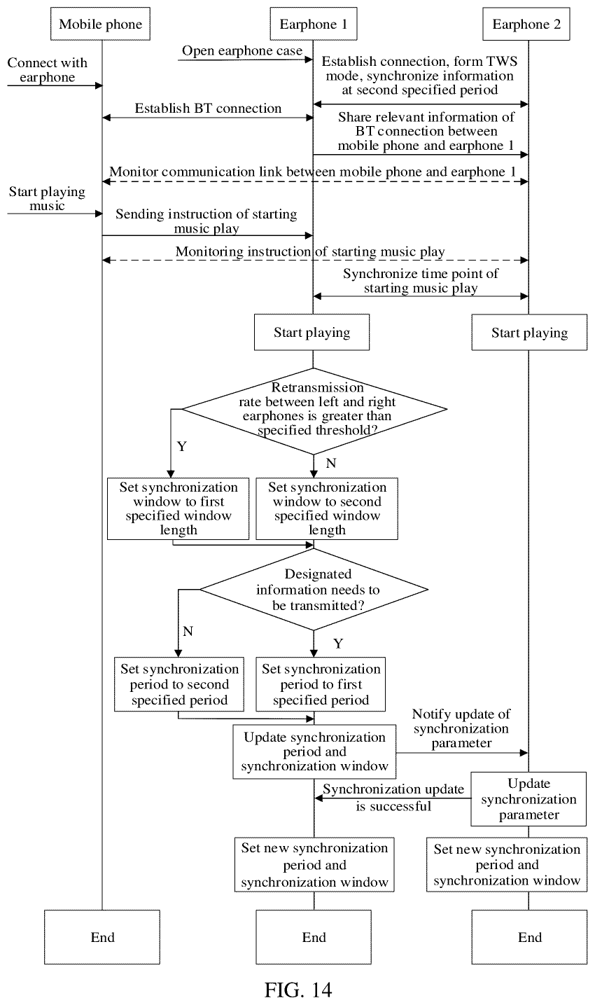

As illustrated in FIG. 14, taking the audio source device as a mobile phone, the first audio playback device as earphone 1, and the second audio playback device as earphone 2 as an example, the parameter configuration method provided in the embodiments of the present disclosure will be further explained.

As illustrated in FIG. 14, when earphones 1 and 2 are placed in an earphone case, if the earphone case is in an open state, earphones 1 and 2 may establish a connection to enter a TWS (True Wireless Stereo) mode. Earphone 1 serves as a main device and first establishes a BT connection (Bluetooth connection) with the mobile phone. After earphone 1 establishes a communication link with the mobile phone, earphone 1 may transmit, to earphone 2, relevant information of the BT connection with the mobile phone. The related information may include Link Key. After receiving the relevant information, earphone 2 may start to monitor the communication link between the mobile phone and earphone 1.

After the mobile phone starts playing music, the mobile phone may send a music playing instruction to earphone 1. After that, after synchronizing the time point of starting to play music, earphone 1 and earphone 2 may start playing the music synchronously, and then enter the operating state illustrated in the aforementioned embodiment.

After earphone 1 and earphone 2 start playing the music synchronously, it may start to detect whether the first retransmission rate between the left and right earphones (between earphone 1 and earphone 2) is greater than a specified threshold, or detect whether there is a designated message to be transmitted. When it is detected that the first retransmission rate between the left and right earphones is greater than the specified threshold, the length of the synchronization window between earphone 1 and earphone 2 may be set to a first window length. Correspondingly, when it is detected that the first retransmission rate between the left and right earphones is not greater than the specified threshold, the length of the synchronization window between earphone 1 and earphone 2 may be set to a second window length, where the first window length is greater than the second window length. If it is detected that there is a designated message needing to be transmitted, the synchronization period between earphone 1 and earphone 2 may be set to a first specified period. If it is detected that there is no designated message needing to be transmitted, the synchronization period between earphone 1 and earphone 2 may be set to a second specified period.

As an implementation, the first retransmission rate may be periodically detected, and after the first retransmission rate is detected, it may immediately detect whether there is a designated message needing to be transmitted, so that the synchronization period and synchronization window may be updated synchronously as illustrated in FIG. 14. Of course, earphone 1 may also only update the synchronization window, or may also only update the synchronization period.

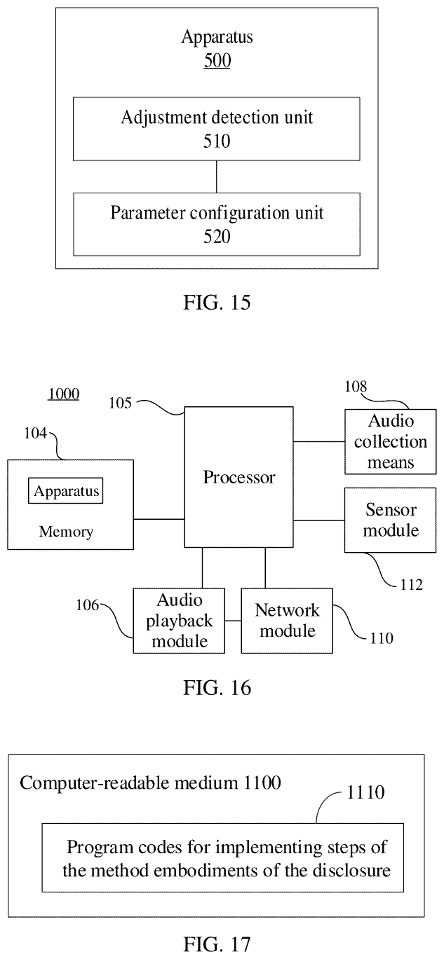

As illustrated in FIG. 15, a parameter configuration apparatus 500 provided in an embodiment of the present disclosure is shown. The parameter configuration apparatus runs on an audio device group, the audio device group includes a first audio playback device and a second audio playback device. The parameter configuration apparatus device 500 includes an adjustment detection unit 510 and a parameter configuration unit 520.

The adjustment detection unit 510 is configured to, when the first audio playback device and the second audio playback device are in an operating state, in response to a parameter adjustment condition being met, cause the first audio playback device to acquire a synchronization parameter configuration strategy corresponding to the parameter adjustment condition.

The parameter configuration unit 520 is configured to cause the first audio playback device to adjust, based on the synchronization parameter configuration strategy, synchronization parameters of the first audio playback device and the second audio playback device, so that information transmission between the first audio playback device and the second audio playback device is performed based on the adjusted synchronization parameters.

As an implementation, the parameter adjustment condition includes that: a first retransmission rate between the first audio playback device and the second audio playback device meets a retransmission rate condition, and/or it is detected that there is designated information needing to be synchronized. The synchronization parameter configuration strategy corresponding to the parameter adjustment condition includes: adjusting a synchronization window between the first audio playback device and the second audio playback device, and/or adjusting a synchronization period between the first audio playback device and the second audio playback device.

As an implementation, the parameter adjustment condition includes that the first retransmission rate between the first audio playback device and the second audio playback device meets the retransmission rate condition, the retransmission rate condition includes that the first retransmission rate is greater than a specified threshold. The synchronization parameter configuration strategy corresponding to the parameter adjustment condition includes: increasing the synchronization window between the first audio playback device and the second audio playback device. In this implementation, the parameter configuration unit 520 is specifically configured to increase the length of the synchronization window between the first audio playback device and the second audio playback device to a first specified window length.

Optionally, the parameter configuration unit 520 is further configured to detect whether the first retransmission rate is lower than the specified threshold; and when it is detected that the first retransmission rate is not lower than the specified threshold, shorten the synchronization period between the first audio playback device and the second audio playback device.

As an implementation, the adjustment detection unit 510 is specifically configured to: when it is detected that there is designated information needing to be synchronized, determine that the parameter adjustment condition is met. In this implementation, the synchronization parameter configuration strategy corresponding to the parameter adjustment condition includes: shortening the synchronization period between the first audio playback device and the second audio playback device. Optionally, the parameter configuration unit 520 is specifically configured to shorten the synchronization period between the first audio playback device and the second audio playback device to a first specified period.

As an implementation, the parameter configuration unit 520 is specifically configured to send an instruction for synchronization parameter adjustment to the second audio playback device, so as to instruct the second audio playback device to adjust the synchronization parameter of the second audio playback device based on the synchronization parameter configuration strategy; and after information indicating that the instruction has been successfully responded is received from the second audio playback device, adjust the synchronization parameter of the first audio playback device based on the synchronization parameter configuration strategy.

Optionally, the instruction carries an update time, and the instruction for synchronization parameter adjustment is specifically configured to instruct the second audio playback device to adjust the synchronization parameter of the second audio playback device based on the synchronization parameter configuration strategy and the update time. Correspondingly, the parameter configuration unit 520 is specifically configured to adjust the synchronization parameter of the first audio playback device based on the synchronization parameter configuration strategy and the update time.

The parameter configuration unit 520 is further configured to, in response to the first audio playback device and the second audio playback device entering the operating state, increase the synchronization window between the first audio playback device and the second audio playback device, and/or shorten the synchronization period between the first audio playback device and the second audio playback device.

In the parameter configuration apparatus provided in the embodiment, when the first audio playback device and the second audio playback device are in an operating state, in response to detecting that a parameter adjustment condition is met, the synchronization parameters of the first audio playback device and the second audio playback device are adjusted based on a synchronization parameter configuration strategy corresponding to the parameter adjustment condition. In this way, the synchronization parameters, based on which the information transmission between the first audio playback device and the second audio playback device is performed, can be changed in real time according to the parameter adjustment condition, thereby improving the flexibility of information transmission between multiple audio playback devices.

It is notable that those skilled in the art can clearly understand that, for the convenience and brevity of description, the specific working processes of the above-described apparatus and units may refer to the corresponding processes in the aforementioned method embodiments, which will not be repeated here. In several embodiments provided in the present disclosure, the coupling between modules may be electrical. In addition, the individual functional modules in the embodiments of the present disclosure may be integrated into one processing module, or each module may exist physically separately, or two or more modules may be integrated into one module. The above integrated module may be implemented in the form of hardware or software functional modules.

An electronic device provided by an embodiment of the present disclosure is described below in conjunction with FIG. 16.

As illustrated in FIG. 16, based on the above parameter configuration method and apparatus, an embodiment of the present disclosure further provides an audio playback device 1000 capable of executing the above parameter configuration method. The audio playback device 1000 includes one or more processors 105 (only one is shown in the figure), a memory 104, an audio playback module 106, and an audio collection means 108, which are coupled to each other. The memory 104 stores a program that can execute the contents of the aforementioned embodiments, and the processor 105 can execute the program stored in the memory 104. The audio playback device 1000 may be used as the first audio playback device in the aforementioned embodiment, or may be used as the second audio playback device.

The processor 105 may include one or more processing cores. The processor 105 uses various interfaces and lines to connect the various parts of the entire audio playback device 1000, and performs various functions and processes data of the audio playback device 1000 by running or executing instructions, programs, code sets or instruction sets stored in the memory 104, and calling data stored in the memory 104. Optionally, the processor 105 may be implemented in at least one hardware of digital signal processing (DSP), field-programmable gate array (FPGA), and programmable logic array (PLA). The processor 105 may integrate one or a combination of a central processing unit (CPU), a graphics processing unit (GPU), a modem, and the like. The CPU mainly processes the operating system, user interface and applications. The GPU is responsible for rendering and drawing display content. The modem is used to handle wireless communications. It is understandable that the modem may not be integrated into the processor 105, but may be implemented separately through a communication chip.

The memory 104 may include a random access memory (RAM) or a read-only memory (ROM). The memory 104 may be used to store instructions, programs, codes, code sets, or instruction sets. For example, the memory 104 may store an apparatus which may be the aforementioned apparatus 500. The memory 104 may include a program storage area and a data storage area. The program storage area may store instructions for implementing an operating system, instructions for implementing at least one function (such as a touch function, a sound playback function, and an image playback function), instructions for implementing the method embodiments, etc.

Furthermore, in addition to the aforementioned components, the audio playback device 1000 may further include a network module 110 and a sensor module 112.

The network module 110 is used to implement information interaction between the audio playback device 1000 and other devices. For example, a connection may be established with other audio playback devices or other electronic devices, and information interaction may be performed based on the established connection. As an implementation, the network module 110 of the audio playback device 1000 is a radio frequency module, which is used to receive and send electromagnetic waves and realize mutual conversion between electromagnetic waves and electrical signals, so as to communicate with a communication network or other devices. The radio frequency module may include various existing circuit elements for performing these functions, such as an antenna, a radio frequency transceiver, a digital signal processor, an encryption/decryption chip, a subscriber identity module (SIM) card, a memory, and the like. For example, the radio frequency module may interact with external devices by sending or receiving electromagnetic waves.

The sensor module 112 may include at least one sensor. Specifically, the sensor module 112 may include but is not limited to: a motion sensor, an acceleration sensor, and other sensors.

The acceleration sensor may detect the magnitude of acceleration in all directions (generally three axes), and may detect the magnitude and direction of gravity when stationary. It may be used for applications that identify the posture of the audio playback device 1000 (such as switching between landscape and portrait modes, related games, magnetometer posture calibration), vibration recognition related functions (such as pedometer, tapping), etc. In addition, the audio playback device 1000 may also be configured with other sensors such as a gyroscope, a barometer, a hygrometer, and a thermometer, which are not be described in detail here.

The audio collection means 108 is used to collect audio signals. Optionally, the audio collection means 108 includes a plurality of audio collection components which may be microphones.

As illustrated in FIG. 17, a structural block diagram of a computer-readable storage medium provided in an embodiment of the present disclosure is shown. The computer-readable medium 1100 stores program codes, and the program codes can be invoked by a processor to execute the method described in the above method embodiments.

The computer-readable storage medium 1100 may be an electronic memory such as a flash memory, an Electrically Erasable Programmable Read Only Memory (EEPROM), an EPROM, a hard disk, or a ROM. In some implementations, the computer-readable storage medium 1100 includes a non-transitory computer-readable storage medium. The computer-readable storage medium 1100 has a storage space for program codes 1110 for executing any method steps in the above-described methods. The program codes may be read from or written into one or more computer program products. The program codes 1110 may be compressed, for example, in a suitable form.

In summary, with the parameter configuration method and apparatus, the audio device group and the readable storage medium provided in the present disclosure, it may detect whether a parameter adjustment condition is met, and in response to the parameter adjustment condition is met, the first audio playback device can adjust the synchronization parameters of the first audio playback device and the second audio playback device. In this way, the synchronization parameters, based on which the information transmission between the first audio playback device and the second audio playback device is performed, can be changed in real time according to the parameter adjustment condition, thereby improving the flexibility of information transmission between multiple audio playback devices.

Furthermore, the parameter configuration method provided in the embodiments of the present disclosure is not only applicable to the first audio playback device and the second audio playback device that establish a connection with the electronic device for the first time, but also applicable to the first audio playback device and the second audio playback device that have already established a connection with the electronic device.

Finally, it is notable that the above embodiments are only used to illustrate the technical solutions of the present disclosure, rather than to limit it. Although the present disclosure has been described in detail with reference to the aforementioned embodiments, those skilled in the art should understand that they can still modify the technical solutions described in the aforementioned embodiments, or make equivalent replacements for some of the technical features therein. However, these modifications or replacements do not cause the essence of the corresponding technical solutions to deviate from the spirit and scope of the technical solutions of the embodiments of the present disclosure.

What is claimed is:

1. A parameter configuration method, for a first audio playback device, the method comprising:
in response to a parameter adjustment condition being met, adjusting synchronization parameters of the first audio playback device and a second audio playback device, so that information transmission between the first audio playback device and the second audio playback device is performed based on the adjusted synchronization parameters.

2. The method as claimed in claim 1, wherein the method further comprises:
determining that the parameter adjustment condition is met, in response to detecting at least one of: a first retransmission rate between the first audio playback device and the second audio playback device meets a retransmission rate condition, and there is designated information needing to be synchronized; and
the adjusting the synchronization parameters of the first audio playback device and the second audio playback device comprises at least one of: adjusting a synchronization window between the first audio playback device and the second audio playback device, and adjusting a synchronization period between the first audio playback device and the second audio playback device.

3. The method as claimed in claim 1, wherein the method further comprises:
determining that the parameter adjustment condition is met, in response to detecting that a first retransmission rate between the first audio playback device and the second audio playback device is greater than a specified threshold; and
the adjusting the synchronization parameters of the first audio playback device and the second audio playback device comprises: increasing a synchronization window between the first audio playback device and the second audio playback device.

4. The method as claimed in claim 3, wherein the increasing the synchronization window between the first audio playback device and the second audio playback device comprises:
increasing a length of the synchronization window between the first audio playback device and the second audio playback device to a first specified window length.

5. The method as claimed in claim 3, wherein after adjusting the synchronization parameters of the first audio playback device and the second audio playback device, the method further comprises:
detecting a current first retransmission rate between the first audio playback device and the second audio playback device; and
in response to the current first retransmission rate being not lower than the specified threshold, shortening a synchronization period between the first audio playback device and the second audio playback device.

6. The method as claimed in claim 1, wherein the method further comprises: in response to detecting that there is designated information needing to be synchronized, determining that the parameter adjustment condition is met; and
the adjusting the synchronization parameters of the first audio playback device and the second audio playback device comprises: shortening a synchronization period between the first audio playback device and the second audio playback device.

7. The method as claimed in claim 6, wherein the shortening the synchronization period between the first audio playback device and the second audio playback device comprises:
shortening the synchronization period between the first audio playback device and the second audio playback device to a first specified period.

8. The method as claimed in claim 2, wherein the designated information comprises information needing to be transmitted in time, and the information needing to be transmitted in time comprises at least one of information about switching of an operating mode, and information of a connected external device.

9. The method as claimed in claim 1, wherein the adjusting the synchronization parameters of the first audio playback device and the second audio playback device in response to the parameter adjustment condition being met, comprises:
in response to the parameter adjustment condition being met, acquiring a synchronization parameter configuration strategy corresponding to the met parameter adjustment condition; and
adjusting, based on the synchronization parameter configuration strategy, the synchronization parameters of the first audio playback device and the second audio playback device, wherein different parameter adjustment conditions correspond to different synchronization parameter configuration strategies.

10. The method as claimed in claim 9, wherein the adjusting, based on the synchronization parameter configuration strategy, the synchronization parameters of the first audio playback device and the second audio playback device comprises:
in response to the acquired synchronization parameter configuration strategy comprising adjusting a synchronization window between the first audio playback device and the second audio playback device, adjusting a length of the synchronization window during which the information transmission between the first audio playback device and the second audio playback device is performed; and
in response to the acquired synchronization parameter configuration strategy comprising adjusting a synchronization period between the first audio playback device and the second audio playback device, adjusting a length of the synchronization period at which the information transmission between the first audio playback device and the second audio playback device is performed.

11. The method as claimed in claim 1, wherein the adjusting the synchronization parameters of the first audio playback device and the second audio playback device comprises:
sending, to the second audio playback device, an instruction for synchronization parameter adjustment, so as to instruct the second audio playback device to adjust the synchronization parameter of the second audio playback device; and
in response to receiving, from the second audio playback device, information indicating that the instruction has been successfully responded, adjusting the synchronization parameter of the first audio playback device.

12. The method as claimed in claim 11, wherein the instruction for synchronization parameter adjustment carries an update time, and the instruction for synchronization parameter adjustment is specifically configured to instruct the second audio playback device to adjust the synchronization parameter of the second audio playback device based on the update time;
the adjusting the synchronization parameter of the first audio playback device, comprises:
adjusting the synchronization parameter of the first audio playback device based on the update time.

13. The method as claimed in claim 1, wherein the adjusting the synchronization parameters of the first audio playback device and the second audio playback device in response to the parameter adjustment condition being met, comprises:
while the first audio playback device and the second audio playback device are in an operating state, in response to the parameter adjustment condition being met, adjusting the synchronous parameters of the first audio playback device and the second audio playback device; and
wherein the operating state is a state in which the first audio playback device and the second audio playback device synchronously play audio data sent by an audio source device.

14. The method as claimed in claim 13, wherein the method further comprises:
in response to the first audio playback device and the second audio playback device entering the operating state, setting a length of a synchronization window between the first audio playback device and the second audio playback device to a second specified window length; and
determining that the parameter adjustment condition is met, in response to detecting that a first retransmission rate between the first audio playback device and the second audio playback device meets a retransmission rate condition, and
wherein the adjusting the synchronization parameters of the first audio playback device and the second audio playback device comprises: setting the length of the synchronization window between the first audio playback device and the second audio playback device to a first specified window length, the first specified window length being longer than the second specified window length.

15. The method as claimed in claim 13, wherein the method further comprises:
in response to the first audio playback device and the second audio playback device entering the operating state, setting a synchronization period between the first audio playback device and the second audio playback device to a second specified period; and
determining that the parameter adjustment condition is met, in response to detecting that there is designated information needing to be synchronized, and
wherein the adjusting the synchronization parameters of the first audio playback device and the second audio playback device comprises: setting the synchronization period between the first audio playback device and the second audio playback device to a first specified period, the first specified period being smaller than the second specified period.

16. An audio playback device, comprising a processor and a memory coupled with each other, wherein the memory is configured to store one or more programs which, when being executed by the processor, cause the processor to:
in response to a parameter adjustment condition being met, adjust synchronization parameters of the audio playback device and a further audio playback device, so that information transmission between the audio playback device and the further audio playback device is performed based on the adjusted synchronization parameters.

17. The audio playback device as claimed in claim 16, wherein the one or more programs, when being executed by the processor, further cause the processor to:
determine that the parameter adjustment condition is met, in response to detecting that a first retransmission rate between the audio playback device and the further audio playback device is greater than a specified threshold; and
increase a synchronization window between the audio playback device and the further audio playback device.

18. The audio playback device as claimed in claim 16, wherein the one or more programs, when being executed by the processor, further cause the processor to:
determine that the parameter adjustment condition is met, in response to detecting that there is designated information needing to be synchronized; and
shorten a synchronization period between the audio playback device and the further audio playback device.

19. The audio playback device as claimed in claim 16, wherein the one or more programs, when being executed by the processor, further cause the processor to:
send, to the further audio playback device, an instruction for synchronization parameter adjustment, so as to instruct the further audio playback device to adjust the synchronization parameter of the further audio playback device; and
in response to receiving, from the further audio playback device, information indicating that the instruction has been successfully responded, adjust the synchronization parameter of the audio playback device.

20. A non-transitory computer-readable storage medium storing program codes thereon, wherein the program codes, when being executed by a processor, cause the processor to:
in response to a parameter adjustment condition being met, adjust synchronization parameters of a first audio playback device and a second audio playback device, so that information transmission between the first audio playback device and the second audio playback device is performed based on the adjusted synchronization parameters.
